(19) United States
(12) Patent Application Publication
(10) Pub. No.: US 2021/0323326 A1
(43) Pub. Date: Oct. 21, 2021

(54) PRINTER CARRIAGES

(71) Applicant: HEWLETT-PACKARD DEVELOPMENT COMPANY, L.P., SPRING, TX (US)

(72) Inventors: Lluis Sole Enrech, Sant Cugat del Valles (ES); Ricardo Oltra Ramirez, Sant Cugat del Valles (ES); Jose Angel Villasante Bembibre, Sant Cugat del Valles (ES); Jose Garcia Martinez, Sant Cugat del Valles (ES)

(73) Assignee: HEWLETT-PACKARD DEVELOPMENT COMPANY, L.P., SPRING, TX (US)

(21) Appl. No.: 17/272,463

(22) PCT Filed: Sep. 14, 2018
(86) PCT No.: PCT/US2018/051099

§ 371 Date: Mar. 1, 2021

(51) Int. Cl. B41J 25/00

(52) U.S. Cl. CPC B41J 25/006

(57) ABSTRACT

It is disclosed a carriage, e.g., for a printing system comprising a housing being the carriage to move along a carriage guide, the carriage comprising a drive mechanism attached to the carriage. The drive mechanism comprises a motor having a rotating axis and an intermediate element attached to the rotating axis, being the intermediate element to contact the carriage guide as to move the carriage along the carriage guide.

### BACKGROUND

In a printing operation of a printing device, a carriage, which includes a print head, is moved relative to a print media item for ejection of print agent from the print head onto the print media item. The carriage may move along a carriage guide and may be propelled along the carriage guide by a drive mechanism. A carriage such as that described above can be employed in printing devices for printing inks and in 3D printing devices wherein layers of build material are selectively solidified by layers with the aid of printing fluids that are printed to the layers of build material.

Similarly, in a scanning operation of a scanning device, which may be included in multifunction printers (MFPs) and other devices, a document to be scanned is placed on a transparent window for scanning. The document may be placed, face down (i.e., where “face” refers to the side of the document to be scanned) on one side of the window. A carriage, which has coupled thereto a scan bar including optics for scanning the document, may then be moved along the length of the opposite side of the window, e.g., along a carriage rod. The carriage, and thus the scan bar, may be propelled along the carriage rod by a drive mechanism that includes a motor and a flexible belt.

### BRIEF DESCRIPTION OF THE DRAWINGS

Various example features will be apparent from the detailed description which follows, taken in conjunction with the accompanying drawings, wherein:

FIG. 1 shows a perspective view of an example of a carriage, in this case, for carrying a printhead of a printing system.

FIG. 2 shows a detailed view of the example of FIG. 1.

FIG. 3 shows a side view of the carriage of FIGS. 1 and 2.

FIG. 4 illustrates the movements achieved by an example of a carriage according to an example.

FIG. 5 shows a perspective view of a further example of a carriage for a printing system.

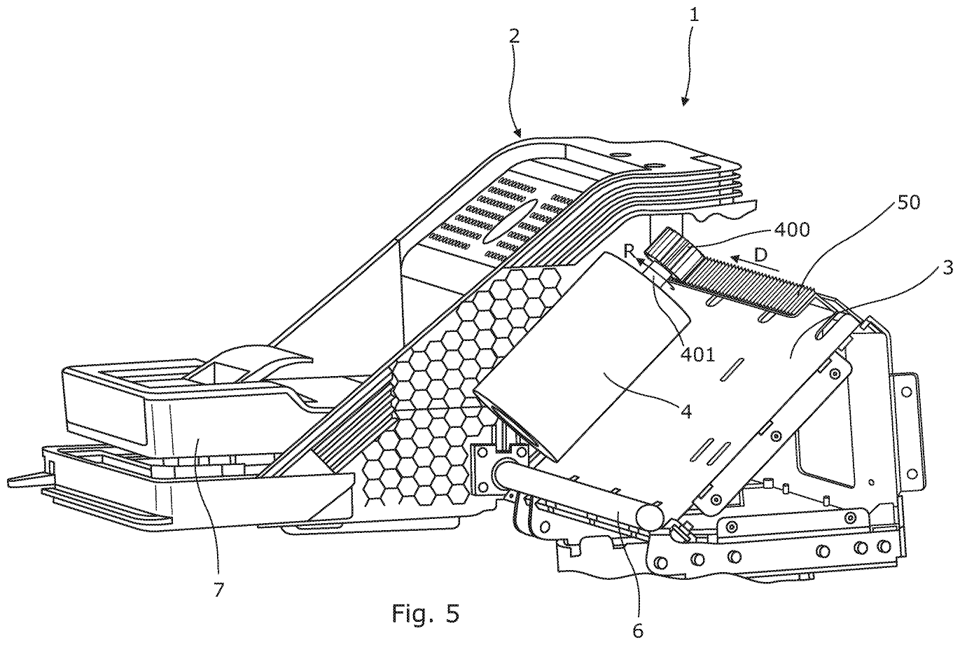

### DETAILED DESCRIPTION

In the following description and figures, some example implementations of print apparatus, print systems, and/or printers are described. In examples described herein, a “printer” or a “printing system” may be a device to print content on a physical medium (e.g., paper, textiles, a layer of powder-based build material, etc.) with a print material (e.g., ink or toner). For example, the printer may be a wide-format print apparatus that prints latex-based print fluid on a print medium, such as a print medium that is size A2 or larger. In some examples, the physical medium printed on may be a web roll or a pre-cut sheet. In the case of printing on a layer of powder-based build material, the print apparatus may utilize the deposition of print materials in a layer-wise additive manufacturing process. A printer may utilize suitable print consumables, such as ink, toner, fluids or powders, or other raw materials for printing. In some examples, a print apparatus may be a three-dimensional (3D) print apparatus. An example of fluid print material is a water-based latex ink ejectable from a print head, such as a piezoelectric print head or a thermal inkjet print head. Other examples of print fluid may include dye-based color inks, pigment-based inks, solvents, gloss enhancers, fixer agents, and the like.

In one example, the present disclosure describes a carriage for use in a printing device. However, in another example, the carriage of the present disclosure can be incorporated in a scanning device.

The carriage disclosed herein comprises a drive mechanism that is used to propel the carriage along a drive direction, the carriage may comprise a coupled a print head, when printing a document. In the present disclosure, the carriage comprises a motor fixedly attached to the carriage, i.e., that moves jointly with the carriage along the drive direction.

Similarly, in the case of a scanning device, the drive mechanism that is used to propel a carriage, to which is coupled a scan bar, when scanning a document comprises a motor coupled to the carriage as to, upon activation of the motor, move together with the carriage.

It is therefore hereby disclosed a carriage comprising a housing being the carriage to move along a carriage guide, the carriage comprising:
a drive mechanism attached to the carriage;
   wherein the drive mechanism comprises a motor having a rotating axis and an intermediate element attached to the rotating axis, being the intermediate element to contact the carriage guide as to move the carriage along the carriage guide.

Examples of intermediate elements may be a rubber wheel or a pinion-rack assembly, i.e., an intermediate element comprising a toothed wheel being with teeth complementary to a set of teeth provided in the carriage guide.

Furthermore, the motor may be a servomotor.

In an example, the carriage may comprise a position sensor to determine the position of the carriage along the carriage guide such as an optical sensor or an encoder associated to the motor, in particular, to the rotational axis activated by the motor.

Moreover, it is herewith disclosed a printing system comprising:
a print medium support surface to support a print medium;
a carriage comprising a housing to receive a printhead, the printhead comprising a set of nozzles to eject a printing fluid towards the print medium;
a carriage guide extending along a drive direction of the print medium support surface;
a drive mechanism to drive the carriage along the drive direction;
   wherein the drive mechanism comprises a motor fixedly attached to carriage, and an intermediate element to convert a rotating movement exerted by the motor to a linear movement of the motor along the carriage guide.

In an example, the intermediate element is a rubber wheel that is to contact the carriage guide. In a further example, the carriage guide comprises a set of teeth and the intermediate element is a toothed wheel with teeth complementary to the set of teeth of the carriage guide.

The system may further comprise an alignment rod parallel to the guide and wherein the carriage slidingly attached to the rod. In an example, the carriage comprises a bore to receive the rod.

In an example, the carriage comprises a position detector to determine the position of the carriage with respect to the carriage guide.

Also, a method to drive a carriage of a printer along a drive direction is disclosed, wherein the carriage comprises a motor attached to carriage as to move jointly with the carriage along a drive direction, the method comprising:
energizing the motor to generate a rotational movement in a rotational axis; and
positioning an intermediate element between the rotational axis and a carriage guide as to convert the rotational movement into a linear movement along the carriage guide.

In an example of the method, the intermediate element is a rubber wheel, however, in other examples, the intermediate element may be a rack-pinion assembly

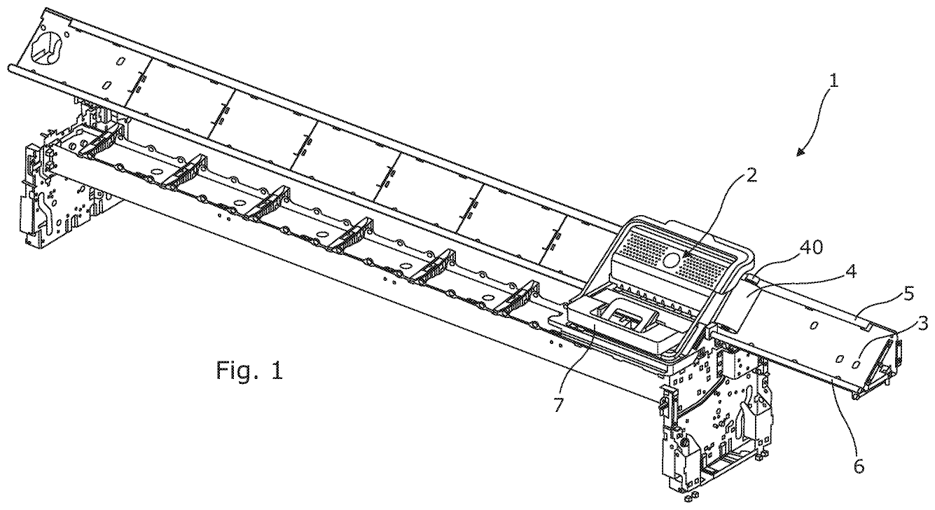

FIG. 1 shows an example of a carriage 2 for use as part of a printing system 1. In the example of FIG. 1, it is shown part of a printing system 1 wherein some elements have been removed to increase the intelligibility of the figure. The printing system comprises a carriage 2 that is to house a printing element, e.g., a printhead 7 or, in another example, a scanner. The printing system comprises a beam 3 with a length that defines the travel distance of the carriage 2, in particular, the beam 3 comprises a carriage guide 5 that guides the carriage along its movement.

The system may also comprise an alignment rod 6 to ensure the alignment of the carriage with respect to the beam 3. In an example, the alignment rod is enclosed by the carriage so that the carriage 2 slides along the rod 6.

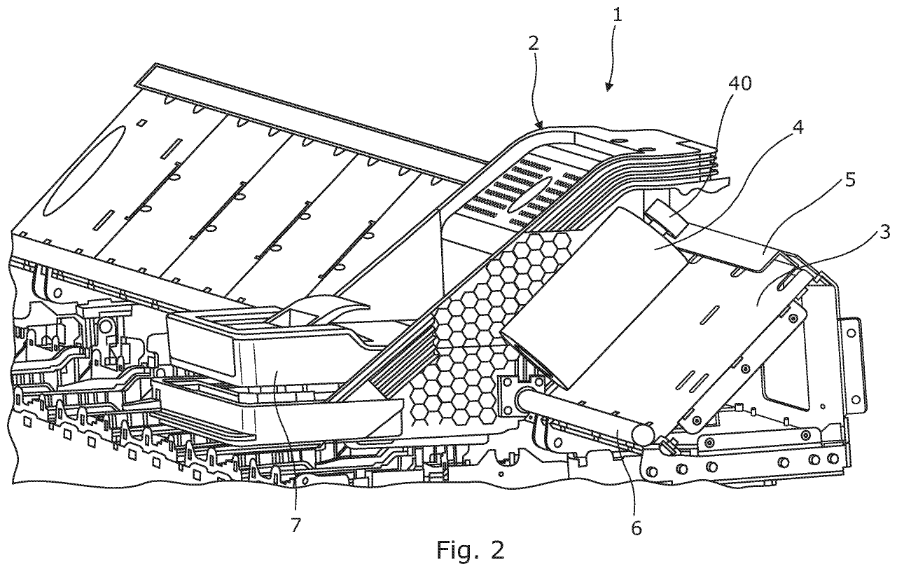

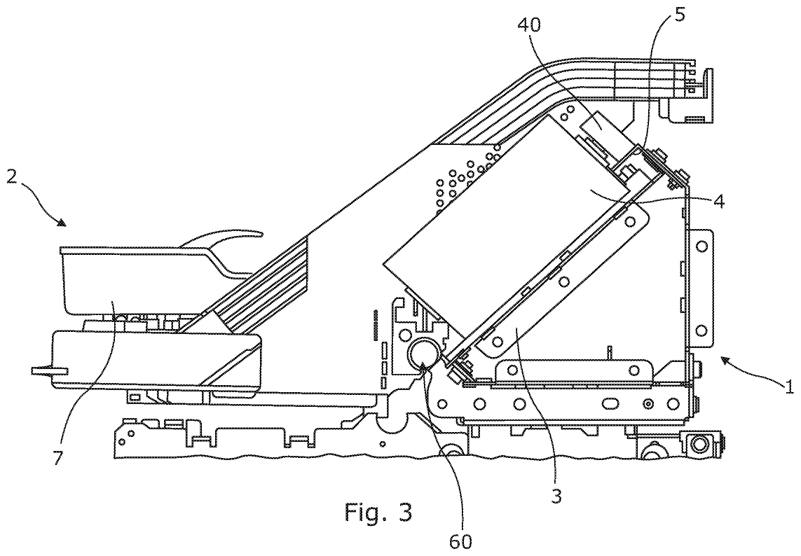

Also, the carriage 2 of FIG. 1 comprises a drive mechanism or an impelling mechanism fixedly attached thereto, i.e., that, in operation, moves together with the carriage 2. The drive mechanism of FIG. 1 comprises an actuator, e.g., a motor 4 and an intermediate element 40 which will be explained in more detail with reference to FIGS. 2 and 3.

FIGS. 2 and 3 show a detailed view of FIG. 1 focusing in the drive mechanism of the carriage 2. FIGS. 2 and 3 show that that the drive mechanism comprises a motor 4 that, through an intermediate element 40 contacts the carriage guide 5 as to traction against such carriage guide thereby achieving a movement of the carriage 2 together with the drive mechanism along the carriage guide.

Furthermore, it is shown in more detail the alignment rod 60 that is to be received by a bore 60 provided in the carriage to allow the displacement of the carriage along the rod 6 thereby ensuring its alignment.

As can be seen, in particular, in FIG. 3, the carriage guide 5 may be a U-shaped or L-shaped profile rigidly attached to the beam 3 as to provide a stepped surface having an upper surface separated from the beam by a larger distance and a lower surface that corresponds to the beam 3 or is closer to the beam than the upper surface. Such a configuration allows for the system to accommodate elements with a larger volume, e.g., the motor 4, or even the carriage in the lower surface whereas the upper surface contacts the intermediate element 40 that is to move the carriage. Also, such a configuration may be made so that the traction is performed on the upper half of the carriage and, preferably, substantially at a height that corresponds to the center of mass of the carriage, thereby further helping with the alignment of the carriage 2 along its movement.

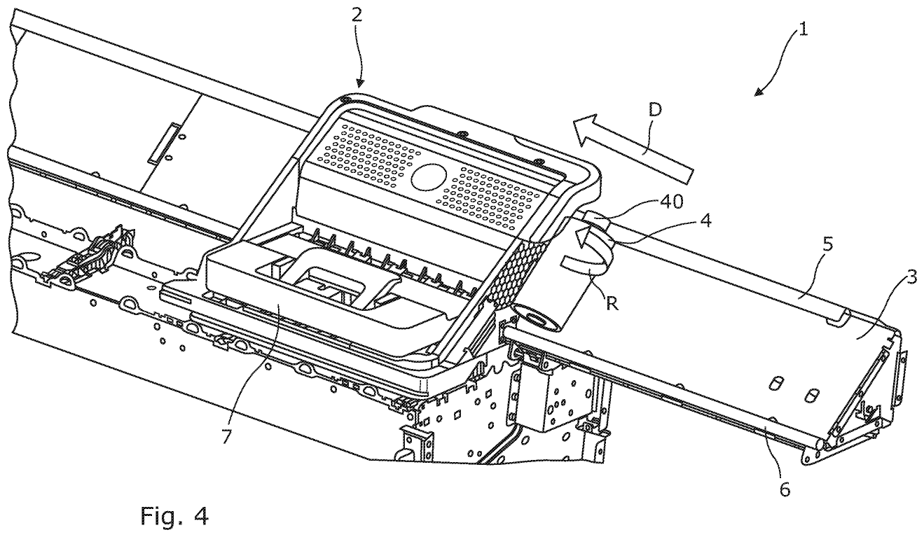

FIG. 4 shows the functioning of an example of a drive mechanism for a printing system 1. In the example of FIG. 4, the drive mechanism comprises a motor 4, for example, a servomotor that may be fed by an energy source by pulse width modulation (PWM) signal. In response to the receipt of the energy from the energy source the motor 4 may generate a rotational movement (R) in an axis. Then, the motor may comprise an intermediate element 40 to transform such rotational movement (R) into a linear movement (D) along a carriage guide 5. In the example of FIG. 4 this is achieved by providing a frictional surface between the carriage guide 5 and the rotational axis, particularly, by using a rubber wheel as intermediate element 40. In an example, the rack 50 may be a plastic or rubber rack. Also, the pinion or intermediate element 40 may be a plastic or rubber toothed wheel.

In this example, the rubber wheel tractions against the carriage guide 5 achieving a linear movement along the drive direction (D). In a further example, the carriage guide 5 may also comprise an enhancer, e.g., a coating and/or plastic component to increase the friction between the guide 5 and the intermediate element 40 thereby preventing slippage.

Also, in an example, the carriage 2 may be provided with a position sensor that moves together with the carriage 2. This sensor may be an optical sensor to help determine the relative position of the carriage 2 along the guide 5 and may comprise a communication channel with a processor within the system as to provide the system with position information of the carriage 2. In a further example, the position sensor may comprise an encoder associated to the motor 4 that may help in determining the position of the carriage 2 along the guide 5.

The carriage 2 comprises a housing that, in an example, is to receive a printhead, the printhead comprising a set of nozzles to eject a printing fluid towards the print medium. In other examples, the carriage 2 may be associated to a scan bar and may be moved along the length of a substrate as to scan it.

FIG. 4 shows a further example of a driving mechanism according to an example. In the example of FIG. 4 the driving mechanism comprises a motor 4 that has a rotational axis 401 activated by the motor and a transducer from a rotational movement (R) of the axis 401 into a linear movement (D) of the carriage along a drive direction. In the example of FIG. 4, the transducer comprises a toothed wheel 400 that has teeth complementary to a set of teeth in a rack 50 provided as carriage guide thereby providing a rack and pinion assembly.

The preceding description has been presented to illustrate and describe certain examples. Different sets of examples have been described; these may be applied individually or in combination, sometimes with a synergetic effect. This description is not intended to be exhaustive or to limit these principles to any precise form disclosed. Many modifications and variations are possible in light of the above teachings. It is to be understood that any feature described in relation to any one example may be used alone, or in combination with other features described, and may also be used in combination with any features of any other of the examples, or any combination of any other of the examples.

1. A carriage comprising a housing being the carriage to move along a carriage guide, the carriage comprising:
a drive mechanism attached to the carriage;
wherein the drive mechanism comprises a motor having a rotating axis and an intermediate element attached to the rotating axis, being the intermediate element to contact the carriage guide as to move the carriage along the carriage guide.

2. The carriage of claim 1 wherein the intermediate element comprises a rubber wheel.

3. The carriage of claim 1 wherein the intermediate element comprises a toothed wheel being with teeth complementary to a set of teeth provided in the carriage guide.

4. The carriage of claim 1 wherein the motor is a servomotor.

5. The carriage of claim 1 further comprising a position sensor to determine the position of the carriage along the carriage guide.

6. The carriage of claim 5 wherein the position sensor comprises an encoder associated to the rotating axis.

7. The carriage of claim 5 wherein the position sensor comprises an optical sensor.

8. A printing system comprising:
a print medium support surface to support a print medium;
a carriage comprising a housing to receive a printhead, the printhead comprising a set of nozzles to eject a printing fluid towards the print medium;
a carriage guide extending along a drive direction of the print medium support surface; and
a drive mechanism to drive the carriage along the drive direction;
wherein the drive mechanism comprises a motor fixedly attached to carriage, and an intermediate element to convert a rotating movement exerted by the motor to a linear movement of the motor along the carriage guide.

9. The system of claim 8 wherein the intermediate element is a rubber wheel that is to contact the carriage guide.

10. The system of claim 8 wherein the carriage guide comprises a set of teeth and the intermediate element is a toothed wheel with teeth complementary to the set of teeth of the carriage guide.

11. The system of claim 8 wherein the system further comprises an alignment rod parallel to the guide and wherein the carriage slidingly attached to the rod.

12. The system of claim 11 wherein the carriage comprises a bore to receive the rod.

13. The system of claim 8 further comprising a position detector to determine the position of the carriage with respect to the carriage guide.

14. A method to drive a carriage of a printer along a drive direction wherein the carriage comprises a motor attached to carriage as to move jointly with the carriage along a drive direction, the method comprising:
energizing the motor to generate a rotational movement in a rotational axis; and
positioning an intermediate element between the rotational axis and a carriage guide as to convert the rotational movement into a linear movement along the carriage guide.

15. The method of claim 14 wherein the intermediate element is a rubber wheel.
